(19) United States
(12) Patent Application Publication
(10) Pub. No.: US 2005/0288419 A1
(43) Pub. Date: Dec. 29, 2005

(54) Polymeric article having a multilayer film including at least one pigmented layer, method of making the same, and pigment additive package and composition suitable for use therein

(75) Inventors: Christian G. Mayville, St. Clair Shores, MI (US); Christopher J. Wawsczyk, Mount Clemens, MI (US); Jeffrey S. Hutchison, Lake Orion, MI (US)

Correspondence Address: YOUNG & BASILE, P.C., 3001 WEST BIG BEAVER ROAD, SUITE 624, TROY, MI, 48084, US

(73) Assignee: Mayco Plastics, Inc., Sterling Heights, MI (US)

(21) Appl. No.: 11/106,082

(22) Filed: Apr. 14, 2005

Related U.S. Application Data
(60) Provisional application No. 60/562,170, filed on Apr. 14, 2004.

(51) Int. Cl. C08K 3/08

(52) U.S. Cl. 524/439

(57) ABSTRACT

A layered film having at least one layer containing particulate pigment in an extrudable thermoplastic material such as an ionomer, ionomeric precursor or the like, and a molded article containing the same. The layered film can be produced by an extrusion process.

### BACKGROUND

The present invention claims priority to U.S. Provisional Application Ser. No. 60/562,170 filed Apr. 14, 2004.

The present invention pertains to polymeric articles having pigmented multilayer polymeric films defining at least a portion of the outer surface. More particularly, the present invention pertains to articles having a multilayer film composed of at least one ionomeric layer and methods for making the same. Furthermore, the present invention pertains to additive concentrates for use in multilayer films and methods for making the same.

The aesthetic value and desirability of various items can be enhanced if the items can be formulated in a variety of colors or hues. For instance, various native polymeric materials exist in shades of gray, or natural tans. To render these more pleasing, it has been contemplated that the materials can be pigmented with various shades. However, the finish of the polymeric articles can lack the sheen, luster, or beauty desired.

It has been proposed that the polymeric substrate be painted or overlaid by a suitable pigmented lacquer material applied in a spray, dip, or brush application process. However, such processes are labor intensive, may not impart the desired surface finish, and can present surface adhesive difficulties. Accordingly, it has been proposed that a polymeric film be integrated into overlying relationship with the desired surface or surfaces of a polymeric substrate. The polymeric film can be composed of one or more layers with at least one layer colored to the desired shade or hue. Such films can be integrated with the substrate article by various methods. One such example of a suitable method includes injection molding processes.

Heretofore, such colored polymeric films have been successfully manufactured by casting processes. However, such processes are labor intensive and present difficulties when multilayer film constructs are desired. Extrusion methods have been proposed in the past. However, extrusion methods producing multilayer films suitable for use as a colored or pigmented outer layer have been problematic. Extruded films using materials such as various polymeric materials such as ionomers in one or more of the multiple layers of the film construct have been difficult to produce successfully. Integration of pigment components into the appropriate layer and incorporation into the suitable substrate article has resulted in areas of undesirable discoloration and/or discontinuity in characteristics such as color and texture in the surface or interior surface regions of the finished product.

Thus, it would be desirable to provide a multilayer film having at least one pigmented layer that can be integrated into or onto the surface of desired substrate article to produce a substantially uniform, aesthetically pleasing outer surface. It is also desirable to provide an article having an outer surface that has an aesthetically pleasing, uniform color characteristic that incorporates pigment components. It would also be desirable to provide a method for producing a suitable polymeric film, particularly utilizing extrusion techniques. Finally, it would be desirable to provide a pigment concentrate that can be integrated into a polymeric matrix to produce a suitable polymeric multilayer film.

### SUMMARY

Disclosed herein is an article having a substrate and an outer surface composed of a polymeric film. The film has suitable pigment material dispersed in at least one layer of a multilayer film construct. The film is composed of extrudable thermoplastic material and is characterized by essentially uniform polymerization characteristics throughout the layer. The pigmented film can include multiple layers such as a polymeric exteriorly oriented clear layer, a pigmented ionomeric layer underlying the clear coat, a suitable backing layer composed of an appropriate polymer such as a polyalkylene polymer associated with the pigmented ionomeric layer, and a suitable tie layer interposed between the backing layer and the pigmented ionomeric layer.

The particulate pigment can be integrated into the polymeric matrix construct during film formation. The particulate pigment is present as particles dispersed in a suitable polymeric carrier material that is readily dispersed in the ionomeric process stream during the film formation process. The resulting film can be introduced into a suitable mold cavity and subjected to suitable article formation processes such as injection molding.

### DESCRIPTION OF THE DRAWINGS

The objects, features, and advantages of the disclosure herein will become more readily apparent from the following description, reference is being made to the following drawings in which:

FIG. 1 is a sectional view through a polymeric film material as disclosed herein;

FIG. 2 is a cross-sectional view of a film coating depicting inclusions, agglomerations, and irregularities as found in prior art methods;

FIG. 2A is a cross-sectional view of a film coating depicting inclusions, agglomerations, and irregularities as found in prior art methods with a pigment focus;

FIG. 3 is a process flow diagram outlining a general process of providing an article as disclosed herein; and

FIG. 4 is a process flow diagram outlining detailed process as disclosed herein.

### DESCRIPTION OF THE EMBODIMENT

Disclosed herein is a polymeric film having particulate pigment material dispersed in a polymeric matrix exhibiting essentially uniform polymerization characteristics throughout. The polymeric matrix includes an ionomeric compound or compounds integrated therein. The film may have multiple additional layers including, but not limited to, unpigmented or clear layers, backing or reinforcement layers, tie or adhesion layers, and the like. Additionally, the polymeric film may optionally include multiple layers each containing different pigments to achieve appropriate color, hue, or visual characteristics. The film disclosed herein is one suitable for incorporation into or onto the surface region of a suitable polymeric article or work piece.

The particulate pigment may be any suitable solid material that can be incorporated in the polymeric matrix of the given polymeric layer. The particulate material can be any suitable geometric shape including, but not limited to, flakes, spheres, granules or the like to provide suitable color and optical qualities. The particulate pigment may be of any size or size range suitable for incorporation in the polymeric material and film and to provide suitable color and optical qualities. It is contemplated that particulate pigment will have a particle size sufficient to provide visible characteristics. Typically the particulate pigment has a size greater than 10 microns. The particulate pigment will have a size between the limits of visible perception and an upper range bounded by the layer thickness. It is contemplated that the particulate pigment will have a size maximum below 0.002 to 0.05 inch.

Also disclosed herein is a method for preparing a polymeric film containing an ionomeric constituent and particulate pigment material dispersed therein. The pigment material is initially incorporated in a suitable carrier medium that disperses readily into the ionomeric constituent of the polymeric film during the film formation process. The pigment material concentrate can be present as pellets that can be incorporated into a suitable polymeric feed stream during suitable extrusion processes and produced into a film layer, either by direct incorporation or melt processing prior to integration into the polymeric feed stream.

The multilayer plastic film 12, disclosed herein, can be made using a suitable polymeric coextrusion process. The multilayer polymeric film 12 can be composed of at least one polymeric layer containing particulate pigment disposed therein. Typically, the polymeric film 12 will be composed of coextruded layers of two or more materials typically including an outer clear layer 14 in overlying relationship to a pigmented polymeric layer 16. Layers 14 and 16 can be positioned in overlying relationship to a backing layer 18 and can be suitably adhered to the backing layer 18 by a suitable tie layer 20. The various layers, 14, 16, 18, and 20 form a unitary coextruded film such as thermoplastic film 12.

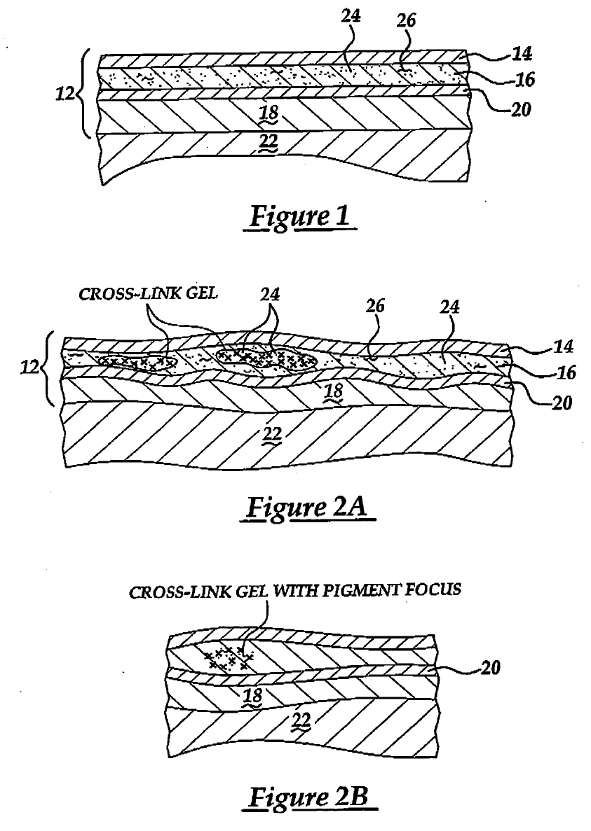

As depicted in FIG. 1, the film 12 is adhered in overlying relationship to a suitable substrate 22. Substrate 22 is typically placed into essentially permanent contact with the film 12 through a suitable process such as injection molding and can be composed of any suitable material compatible with film 12. It is contemplated that the substrate 22 can be associated with any suitable end use article. One nonlimiting example of such articles includes but is not limited to bumpers, automotive fascia, body panels and the like, both for interior and exterior applications.

As disclosed herein, the thermoplastic film 12 includes appropriate pigmentation and color augmentation present as pigment particles 24 dispersed throughout at least one layer of the film 12. As depicted herein, pigment particles 24 are dispersed through pigmented polymeric layer 16. The film 12 may also include suitable materials that augment the color or visual perception of the material. Examples of these materials include, but are not limited to, metallic particles or flakes 26, various opalescence additives, and the like.

It is contemplated that the outermost or clear layer 14 may be composed of any suitable clear or optically transmissive polymeric material. Examples of suitable thermoplastic materials include, but need not be limited to, ionomers derived from sodium, lithium, or zinc, and ethylene/unsaturated carboxylic acid or anhydride copolymers. Suitable ionomer resins include, but are not limited to, those available from Dupont under the trade name SURLYN. These resins are identified as being derived from sodium, lithium, or zinc, and copolymers of ethylene and methacrylic acid. Included in this group are sodium-containing ionomers available under the SURLYN name and having the following designations: 1601, 1605, 1707, 1802, 1901, and the like. Also included are zinc-containing ionomers available under the SURLYN name having the following designations: 1650, 1652, 1702, 1705-1, 1855, and 1857. Lithium-containing ionomers available under the SURLYN name include the following designations: AD8546, 7930, and 7940.

It is contemplated that suitable acid copolymers of various alkylenes and carboxylic acid and/or anhydrides can be neutralized in whole or in part with metal ions such as sodium, lithium, and/or zinc. The degree of neutralization can vary depending upon the particular compound characteristics. Ionomeric material is available from various sources. Nonlimiting examples of such sources include A. Schulman under the trade name FORMION and Exxon Mobile under the trade name IOTEK.

As defined herein, the term “clear” as used with the clear layer 14 is defined as a material that can be seen through. The term “optically transmissive” as used herein is taken to mean transmissive to desired wavelengths of electromagnetic radiation such as in visible light. Generally transmissivities greater than 50 percent of visible light are contemplated with high transmisivities of greater than 90 percent being useful. The polymeric material of choice employed in the clear layer 14 can be one that imparts suitable scratch and abrasion resistance as desired or required. As such, it is contemplated that the clear layer can include suitable abrasion resistance enhancing additives as would be known to the skilled artisan. It is also contemplated that the clear layer can include additives which impart ultraviolet resistance and resistance to other undesirable environmental factors. Once again, such additives are typically known to the skilled artisan.

Where the clear layer contains materials as discussed previously, it is contemplated that concentrations of light stabilizers such as ultraviolet (UV) light absorbers and/or other light stabilizers can be employed. These additives are included to provide characteristics such as enhanced outdoor weatherability properties. The concentrations of light stabilizers in the clear layer can be in any suitable range. Exemplary ranges include about 1,000 to about 20,000 ppm based on the weight of the clear layer 14. Exemplary concentrations can, more specifically, include concentrations in the range of about 2,000 to about 20,000 ppm based on weight with more specific ranges varying from about 5,000 to about 20,000 ppm, or about 8,000 to about 18,000 ppm. Useful light stabilizers include the hindered amine light stabilizers. The hindered amine light stabilizers may, for example, be derivatives of 2,2,6,6-tetraalkyl piperidines or substituted piperizinediones. A number of hindered amine light stabilizers useful in the invention are available commercially such as from Ciba-Geigy Corporation under the general trade designations “Tinuvin” and “Chemissorb”, and from Cytec under the general designation “Cyasorb-UV.” Examples include Tinuvin 783 which is identified as a mixture of poly [[60[(1,1,3,3,-tetramethylbutyl)amino]-1,3,5-triazine-2,4-diyl][[2,2,6,6-tetramethyl-4-piperidyl)imino]hexamethylene [(2,2,6,6-tetramethyl-4-piperidyl)imino]] and dimethyl succinate polymer with 4-hydroxy-2,2,6,6-tetramethyl-1-piperidineethanol; Tinuvin 770 which is identified as bis-(2,2,6,6-tetramethyl-4-piperidinyl)-sebacate; Tinuvin 765 which is identified as bis-(1,2,2,6,6-pentamethyl-4-piperidinyl)-sebacate; Tinuvin 622 which is a polyester of succinic acid and N-beta-hydroxy ethyl-2,2,6,6-tetramethyl-4-hydroxy-piperidine; and Chemissorb 944 which is poly[6-(1,1,3,3-tetramethylbutyl)amino]-s-triazine-2,4-diy[[2,2,6,6-tetram ethyl-4-piperidyl)imino]hexamethylene (2,2,6,6-tetramethyl-4-piperidyl)imino]. A useful stabilizer is available under the trade name Ampacet 10561 which is a product of Ampacet identified as a UV stabilizer concentrate containing 20% by weight of a UV stabilizer and 80% by weight of a low density polyethylene carrier resin; the UV stabilizer in this product is Chemissorb 944. Useful light stabilizers are also provided in Ampacet 150380 and Ampacet 190303, both of which are pigment concentrates discussed above. Ampacet 150380 has a UV stabilizer concentration of 7.5% by weight. Ampacet 190303 has a UV stabilizer concentration of 4% by weight. The UV stabilizer in each of these products is Chemissorb 944. Ampacet LR-89933 is a gray concentrate having a UV stabilizer concentration of 4.5% by weight, the UV stabilizer being Tinuvin 783.

Various materials and compounds can be added to enhance scuff and abrasion resistance during processing and/or during the life of the resulting article. Non-limiting examples of these materials include primary amides such as stearamide, behenamide, oleamide, erucamide, and the like; secondary amides such as stearyl erucamide, erucyl erucamide, oleyl palimitamide, stearyl stearamide, erucyl stearamide, and the like; ethylene bisamides such as N,N-ethylenebisstearamide, N,N-ethylenebisolamide and the like; and combinations of any two or more of the foregoing amides. Examples of suitable additive packages include those utilized as antislip additives. Non-limiting examples of such materials include additive packages available from Dow Chemical such as Elvax CE9619-1. This resin concentrate contains 20% by weight silica, 7% by weight of an amide slip additive, and 73% by weight of Elvax 3170 (a product of DuPont identified as an ethylene/vinyl acetate copolymer having a vinyl acetate content of 18% by weight). The additive can be used at a concentration in the range of up to about 5% by weight, and in one embodiment about 0.01% to about 0.5% by weight. The slip additive can be used at a concentration in the range of up to about 5% by weight, and in one embodiment between 0.01% and 0.5% by weight. In various embodiments, slip additive can be incorporated in amounts greater than 1% utilizing fatty acid based materials. The total amount of material employed will be an amount that is less than that which will adversely effect gloss characteristics for the clear layer. This will generally be amounts less that about 2000 ppm additive by weight of the clear layer, with levels below about 1500 being preferred.

The multilayer polymeric film 12 also includes at least one pigmented polymeric layer 16. The pigmented polymeric layer 16 is typically positioned such that the outer clear layer 14 is in overlying relationship with the pigmented layer 16. As depicted in FIG. 1, the clear layer 14 can be in direct overlying relationship and contact with at least one pigmented layers 16. It is also contemplated that the multilayer polymeric film 12 can include multiple pigmented layers 16 as desired or required. The pigmented layer or layers 16 can include various pigmenting and opacifying agents that will provide the color, hue, and desired level of opacity for the multilayer film 12. The pigmented layer 16 is composed of a suitable melt processible and extrudable thermoplastic polymer or polymers.

The thermoplastic material employed in the pigment layer can be ionomers and ionomeric precursors such as those previously discussed with regard to the clear layer. Examples of suitable ionomers include, but are not limited to, alkylene-unsaturated carboxylic acid and anhydride copolymers neutralized with at least one of sodium, lithium, or zinc, such as neutralized ethylene-methacrylic acid copolymers.

It is contemplated that the polymeric material used in pigmented layer(s) 16 may also include minor amounts of various other polymeric compounds or materials. It is also contemplated that the polymeric material employed in the pigmented polymeric layers 16 can also include various additives such as UV stabilizers and the like, as desired or required. Nonlimiting examples of suitable additives are those listed previously in connection with clear layer 14.

The pigmented polymeric layer 16 can include various materials suitable for providing the appropriate color or hue characteristics as desired or required. Nonlimiting examples of suitable particulate pigments include various metallic pigments, heavy metal-based pigments, heavy-metal free pigments, or various organic pigments. As used herein, a heavy metal pigment is defined as one including lead, cadmium, chromium, or antimony, or complexes derived therefrom. The pigments that can be successfully used include but are not limited to titanium dioxide, both rutile and anatase crystal structure. The titanium dioxide may be coated or uncoated. The pigment can be dispersed in the polymeric matrix in any suitable fashion which will provide the desired color or hue characteristics.

Particulate pigments are compounded into additive formulations that can be readily added to the ionomeric matrix during processing. The pigment additive formulation includes particulate pigments present in polymeric or resin carriers. Suitable carriers include various thermoplastic polymers having a melting point of in the range of about 100° C. to about 175° C. Examples of such materials include polyethylene, polypropylene, polybutylene, ionomeric materials, ionomeric precursors and the like. The pigment material can be present in the additive formulation such that the blend is between 5 percent and 95 percent by weight polymeric carrier matrix, and about 95 percent to about 5 percent particulate pigment material, with ranges between 30 and 70 percent being contemplated. Examples of suitable pigments include those generally found in commercially available pigment packages. One suitable pigment is that employed in the film disclosed herein is commercially available from A. Schulman, Inc. under the trade name Polybatch White P 8555 SD. This material is identified as a white color concentrate having a coated rutile titanium dioxide concentration of 50 percent by weight in a polymeric carrier resin. As used herein, the suitable particulate pigment concentrate material may be present in an ionomeric carrier material in an amount between 5% by weight and 70% by weight. In an embodiment disclosed herein, the pigment is present in the ionomeric carrier in an amount between 5% and 50% by weight.

As used herein, “ionomeric carrier” is taken to mean a polymeric material that can readily disperse into the ionomeric process stream during formation of pigmented layer 16. Suitable matrix materials include ionomers, ionomer precursors, and polymeric materials compatible with ionomers. Nonlimiting examples of ionomers include those previously enumerated with respect to the clear layer 14. “Ionomeric precursors” as that term is used herein is taken to mean homopolymers, acid co-polymers, monomeric compounds, and various constituents used to prepare ionomeric materials. “Ionomeric compatible materials”, as that term is used herein include polymeric materials that can be readily integrated or blended into an ionomeric process stream during a process such as extrusion or co-extrusion. Nonlimiting examples of such materials include various melt processible polyolefins having process temperatures up to about 600° F.

It is contemplated that various pigments of a variety of colors can be advantageously employed in the concentrate matrix. The pigment employed can be one or more particulate materials capable of dispersing in the polymeric matrix which, upon extrusion, yields desired color, hue, and opacity characteristics. The particulate pigment of choice is one capable of maintaining particulate characteristics in both the carrier and resulting polymeric matrix and exhibiting sufficient thermal stability to permit extrusion processing.

It is contemplated that the pigment or pigments employed will be ones that can provide appropriate light reflectivity characteristics as well as color consistency and repeatability from part to part and in each individual part depending on the angle of incidence from which the part is viewed. The pigment(s) of choice will be those that exhibit compatibility with ionomeric material in the melt extrusion process.

Without being bound to any theory, it is believed that at least a portion of the particulate pigment is integrated or associated into the ionic matrix during melt processing and extrusion thereby contributing to dispersion within the matrix and establishing a sufficiently random orientation to contribute to the visual color repeatability of the material.

Nonlimiting examples of these include the pigments used in materials such as Ampacet 150380 and 190303, identified as red and black pigments, respectively, can be employed. It is also contemplated that various lead molybdate/lead chromate pigments as well as various heavy-metal free pigments can be used. Examples of such materials include pigments found in concentrations such as Ampacet LR-86813 Yellow UV PE MB, Ampacet LR-868/10 RED PE MB, Ampacet LR86816 RedPE MP, Amacet LR 86816 Orange and Ampacet LR-86789b Red UV PEMP is identified as a red pigment concentrate. The pigment employed in Ampacet 190303 identified as a black pigment can also be used. It is contemplated that the concentrations of pigment in the resulting pigmented layer 16 can be up to about 25 percent by weight.

As disclosed herein, the pigmented layer may be employed alone or in combination with various other layers. Depending upon the color characteristics desired, it is contemplated that the particulate pigment will be present in the pigment layer such as layer 16 at a concentration greater than about 0.25 wt % with upper concentrations limited by factors such as processing characteristics and optic quality. The polymeric pigment layer 16 will generally have a thickness sufficient to provide desired color characteristics to the associated article or part. It is to be understood that layer thickness may vary from application to application depending on factors including but not limited to end-use application and color considerations. It is contemplated that within a given film construct, layer thickness will be fairly consistent. One nonlimiting example of suitable layer thickness is a pigment layer that is between 6 thousandths and 20 thousandths of a millimeter can be successfully employed in single-layer pigment constructions. In situations where the pigment layer is utilized with an overlying clear layer, the pigment layer/clear layer construction will have a combined layer thickness suitable to provide desired characteristics such as color and wearability. A nonlimiting example of such thicknesses is between 12 and 20 thousandths of a millimeter being contemplated with the pigment layer constituting between 10% and 80% of the clear coat/pigment construct.

The multilayer film construct 12 can further include a suitable backing layer 18. The backing layer 18 can be composed of at least one thermoplastic polymer such as those discussed below. The backing layer may be composed of a single thermoplastic polymer or a blend of thermoplastic polymers as desired or required. The backing layer 18 may also be composed of blends of various thermoplastic polymers and suitable adhesive materials where desired to enhance bonding between the backing layer and associated layers such as pigment layer 16. Additionally, the composition in the backing layer may include other processing components and stabilizing components as desired or required.

As disclosed herein, the backing layer 18 can be composed of various melt-processible polymeric materials. Nonlimiting examples of suitable melt processible polymeric materials include various melt processible polyolefins. Other thermoplastic polymers having similar processing characteristics can be effectively employed as desired or required.

Polyolefins that are useful in the backing layer include, but are not limited to, polyethylene, polypropylene, polybutylene, as well as copolymers of ethylene, propylene or butylenes with various alphaolefins. The alphaolefins include those containing three to eighteen carbon atoms. Such materials include propylene, ethylene, butylenes, butene, hexane, 4-methyl pentene, octane, and the like. It is also contemplated that the polyolefin backing layer may be made of a blend of polyolefins such as polyethylene and various materials such as ethylene propylene copolymers. Medium density polyethylenes and linear medium density polyethylenes can be useful in the construction disclosed herein.

The material of choice will be one that can impart flexible strengthening characteristics to the thermoplastic film 12. Additionally, the material of choice in the backing layer 18 will be one that will exhibit appropriate adhesion or bonding characteristics with the material or materials employed in the substrate 22.

Where desired or required, it is contemplated that the material employed in the backing layer 18 can include suitable compounds or additives to promote adhesion with the ionomeric layer or any appropriate layers interposed there between. It is contemplated that such adhesion-promoting additives will be present as minor amounts of the composition and can include various ionomeric polymeric compounds as previously enumerated as well as compounds that exhibit an affinity to ionomeric materials. Nonlimiting examples of the latter include ionomeric precursors such as acid copolymers.

Where an adhesion promoting compound or material is incorporated into the material of the backing layer, it is contemplated that the incorporation may be homogeneous or nonhomogeneous depending on the nature and characteristics of the respective materials. Where a minor portion of an ionomeric material is blended with the major polymeric material employed in the backing layer 18, it is contemplated that the material may be processed such that the respective materials orient upon extrusion to provide a region proximate to one film surface that is richer in ionomeric material. Without being bound to any theory, it is believed that the ionomeric-rich surface region promotes bonding between the backing layer 18 and associated ionomer layer such as pigment layer 16.

The backing layer can have any thickness desired or required to promote bonding to the underlying substrate. Where employed, the backing layer may also contribute to overall film stability during and after extrusion processing. A nonlimiting example of backing layer thickness is up to 0.500 inch. In certain applications thicknesses between 0.05 and 0.200 inch are employed. Backing layer thickness can vary depending on the specific end use application.

Alternately, it is contemplated that the multilayer film 12 includes a tie or adhesion layer 20 as depicted in FIG. 1. The adhesion layer 20 is composed of at least one melt processible thermoplastic polymer or polymer blend that exhibits an affinity to the overlying pigmented layer 16 containing ionomers and the backing layer 18 respectively. It is contemplated that the adhesion layer 20 is made up of a major portion of a suitable polyolefin. The adhesion or tie layer also contains a minor portion of a second thermoplastic material that exhibits an affinity to the overlying ionomeric layer 16. In a preferred embodiment of the invention as disclosed herein, the second thermoplastic material includes at least one of an ethylene-unsaturated carboxylic acid or anhydride, such as ethylene/acrylic acid copolymers, or ethylene-methacrylic acid copolymers, ionomers derived from sodium, lithium, or zinc, and ethylene/unsaturated carboxylic acid or anhydride such as ethylene-methacrylic acid copolymer. It is also contemplated that combinations of two or more of the foregoing can be employed as the second thermoplastic material. The concentration of the second thermoplastic material is in a range between up to and including 50 percent by weight based on the weight of the tie layer 20. In one embodiment, the concentration of the second thermoplastic polymer is between about 45 percent by weight based on the weight of the tie layer 20.

Nonlimiting examples of polyolefins that can be used in the tie or adhesion layer 20 can include materials such as polyethylene, polypropylene, or polybutylene, as well as copolymers of ethylene, propylene, or butylenes with an alphaolefin. The alphaolefin can be selected from those alphaolefins containing from 3 to about 18 carbon atoms, including propylene, ethylene, butylenes, butene, hexane, 4-methylpentene, and octane. The polyolefin backing layer may be made by a blend of polyolefins such as polyethylene and ethylene propylene copolymers. Medium density polyethylene and the linear medium density polyethylenes are useful. A nonlimiting example of a useful polyolefin is a product available from Schulman under the trade designation FI 134, which is believed to be an anhydride in an olefinic carrier.

As described above, the tie or adhesion layer 20 may include a second thermoplastic material selected from ethylene/unsaturated carboxylic acid or anhydride copolymers, ionomers derived from sodium, lithium, or zinc, and ethylene/unsaturated carboxylic acid or anhydride copolymers, as well as combinations of two or more thereof. Ionomeric resins available from Exxon under the trade designation XV404 believed to contain ionomeric precursors are non-limiting examples of suitable ionomeric materials.

As indicated, previously, it is also contemplated that other suitable adhesive resins can be incorporated directly into the backing layer or interposed as part of a distinct layer between the backing layer 18 and ionomeric layer 16. Nonlimiting examples of suitable adhesive resins can include materials such as ethylene/vinyl acetate copolymers. Suitable ethylene/vinyl acetate copolymers are available from Dupont under the trade designation “Elvax”. Examples include Elvax 3170 and 3190 LG. Adhesive resins available from Dupont under the trade name “Bynel” can also be used. These include ethylene/vinyl acetate resins available under trade designation Series 1100, acid-modified ethylene acrylic polymers (Series 2000), anhydride modified ethylene acrylic copolymers (Series 2100), anhydride-modified ethylene/vinylacetate copolymers (Series 3,000), acid-and-acrylate-modified ethylene/vinyl acetate resins (Series 3100), anhydride-modified ethylene/vinyl-acetate copolymers (series 3800), anhydride-modified ethylene/vinyl acetate resins (Series 3900), anhydride-modified high density polyethylene resins (Series 4,000), anhydride-modified linear low density polyethylene resins (Series 4100), anhydride-modified low density polyethylene resins (Series 4200), and anhydride-modified polypropylene resins (Series 5000). BYNEL CXA 1123 and BYNEL CXA 3101 are specific nonlimiting examples.

As indicated previously, it is contemplated that adhesive materials such as the ionomers or other suitable adhesives can be incorporated directly into the backing layer 18. When included in the backing layer, it is contemplated that the adhesive resin will be used at a concentration up to about 45%, or up to about 25 percent by weight. In one embodiment it is contemplated that the adhesive resin in the backing layer is an amount between about 1 percent and about 15 percent by weight. When used in the form of a distinct film layer between the backing layer and the ionomeric layer, it is contemplated that each of such adhesive resin films will have a thickness about 5 percent to about 25 percent of the thickness of the multilayer film 12, and in one embodiment a thickness between about 10 percent and about 20 percent. In a particular embodiment, for example, it is contemplated that the adhesive layer will have a thickness in a range between 0.001 and 0.05, with a range between 0.002 and 0.010 inch being contemplated and ranges between 0.002 and 0.004 inch being envisioned.

It is contemplated that colored articles 10 according to the embodiment(s) discussed herein include a suitable substrate 22 integrally attached to the backing layer 18. The substrate layer can be of any suitable thickness and configuration as dictated by the specifications and requirements of the finished article 10. The substrate 22 is composed of suitable injectable, melt-processible polymeric material(s). The material(s) of choice may exhibit thermoplastic or thermosetting characteristics. Nonlimiting examples of such materials are engineered polymers such as those characterized as thermoplastic elastomers (TPE). As used herein, the term “thermoplastic elastomer” refers to rubber-like materials that can be processed and recycled as thermoplastics. In particular, olefinic thermoplastic elastomers can be successfully employed. Such materials are commonly referred to as thermoplastic polyolefins (TPO). Olefinic thermoplastic elastomers can be materials having characteristics that allow the various components to soften and permit the polymeric matrix to flow at processing temperatures. When the material of choice cools, the hard segments solidify and re-establish a desirable rubber-like structure. Olefinic TPEs are typically multiphase material that includes crystalline or amorphous polyolefins such as polyethylene, polypropylene, and ethylene/propylene rubbers such as EPDM. Also included are materials such as polybutylene, polyisobutylene, polymethylpentene and the like. Materials of choice can have tensile strength in the range of 1,000 to 3,000 psi and melt temperatures in the range of 3000 to 450° F.

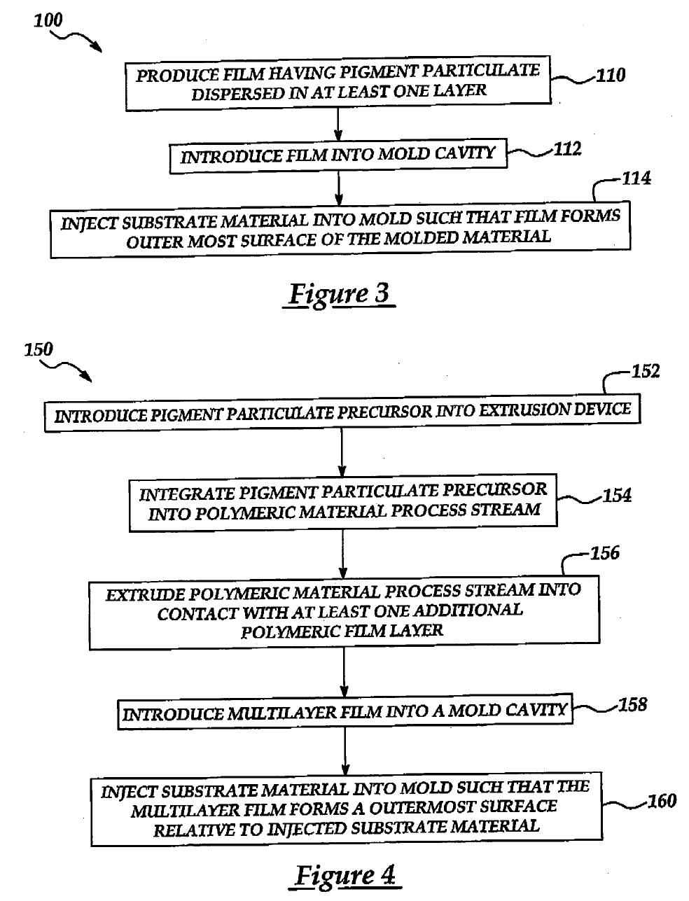

In order to produce an article 10 having a multilayer film 12, it is contemplated that the article 10 can be produced by the method disclosed herein as outlined in FIG. 3. The method 100 involves the step of producing a film having particulate pigment dispersed in at least one layer as at reference numeral 110. The film can be produced by any suitable method. As disclosed herein, it is contemplated that the film is produced by a suitable co-extrusion process utilizing processing temperatures, mixing speeds, and flow rates, that effectively produce a film having at least two layers such that the metallic particulate material is dispersed in at least one layer. It is contemplated that dispersion of the pigmented particulate material is essentially uniform throughout the layer. As used herein, the term “essentially uniform” is taken to mean a dispersion of the pigment material in a manner that exhibits minimal perceptible clumping or agglomeration of the particulate.

Pigment dispersion occurs in a manner that minimizes the introduction or incorporation of volatilizable compounds into the polymeric matrix. Without being bound to any theory, it is believed that incorporation of volatilizable materials occurs due to the presence of additive aids associated with the pigment material. Reduction of such additives with the concomitant addition of pigment material in a suitable ionomeric compatible matrix permits successful integration of pigment into the polymeric matrix of the pigmented layer 16. As disclosed herein additive concentration is maintained at or below a suitable volatilization threshold.

Volatilizable additives include, but are not limited to, water, waxes, encapsulation components, and the like. As defined herein, the term “volatilization threshold” is the additive concentration level above which significant volatilization phenomena is experienced upon subsequent extrusion processing. “Volatilization phenomena” are any process or event whereby at least a portion of the additive is converted to a gaseous material and/or reacts to form at least one gaseous compound or material capable of migrating through the polymeric matrix while in its molten or semi-molten state either during film formation or subsequent molding operations.

Occurrence of volatilization phenomena can be characterized by surface imperfections either at the layer/layer boundary or at the outer film surface of the resulting article. Such imperfections can adversely effect the aesthetic or visual appearance of the finished article.

It has also been found unexpectedly that integration of pigment particles into a compatible concentrate that is then introduced into a process stream containing the polymeric matrix of polymeric layer 16 minimizes the occurrence and formation of gels and gel formation in the polymeric matrix material. As used herein, the germ “gel” is defined as localized regions of polymeric anomalies that mar the appearance and/or texture of the resulting film layer. Without being bound to any theory, it is believed that gels can be the result of a variety of reaction processes. Cross-link gels are the result of undesired crosslinking within the polymeric matrix and/or between the matrix and materials contained therein. The presence of cross-link gels manifests as regions of optical inconsistency and/or discoloration in the film matrix. Cross-link gels can vary in size from single micron regions to areas over 200+ microns in size and greater. Such gels are difficult to remediate and provide a focus for thermal discoloration and surface irregularity.

Entanglement gels have the appearance of cross-link gels but exhibit greater thermoplastic behavior in that portions of the gel region can be reduced or eliminated by appropriate thermal processing. Without being bound to any theory, it is believed that entanglement gels are the result of concentrated regions unreacted acid copolymer that can be converted with application of thermal and/or mechanical energy into the ionomeric polymer. Entanglement gels can vary in size to over 200+ microns in size.

Unmelt gel regions are the result of polymeric material that has been inadequately processed and has failed to enter the melted state in a uniform manner. Size is similar to that of cross-link and/or entanglement gels. The size and severity of unmelt gels can be addressed by application of heat.

It is currently hypothesized that at least a portion of undesired gel formation in the multilayer film 12 is due, at least in part, to interaction between pigment material and the ionomeric constituent in the polymeric matrix. This results in gels having a significant cross-linked characterization. It is believed that careful integration of pigment particulate contained in a polymeric carrier that is readily integratable into the polymeric material employed in layer 16 reduces the occurrence of cross-link gel formation and minimizes the tendency of pigment particles to be the focus of gel formation. Without being bound to any theory, it is believed that particulate pigment, in the presence of ionomeric material in the carrier, serves to neutralize unreacted functionalities in the ionomeric complex thereby integrating the particulate pigment in the matrix and partially reacts to the pigment with the matrix.

The resulting polymeric film and various individual layers is characterized as having polymeric matrix in the film in which the polymeric matrix is an extruded thermoplastic exhibiting essentially uniform polymerization throughout the matrix. As used herein, the term “essentially uniform polymerization” is defined as positioning of the thermoplastic polymeric material in the film layer without undue evidence of atypical polymeric cross-linking either spontaneous or metallic particulate focused. The polymeric matrix described nad contemplated herein exhibits gel formation if at all in which the gels are less than 500 microns in size. Typically gel formation results in gel regions present in the polymeric layer that are widely distributed and have sizes less than 200 microns. Occurrences less than 40 per square inch in the produced film are contemplated.

The pigment concentrate of choice will contain an ionomeric carrier and pigment together with a suitable compatibilizer present in an amount sufficient to disperse the pigment in the carrier and, ultimately, in the polymeric matrix of the polymeric layer 1 16. Suitable compatibilizers include acid copolymer ionomeric precursors in amounts between about 0.5% and 10% by concentrate weight.

As depicted in FIG. 3, the produced polymeric film is introduced into a suitable mold cavity as at reference numeral 1 12. The mold cavity is formed in a suitable injection mold die. The polymeric film is introduced such that the film is positioned proximate to at least a portion of the mold cavity surface. Introduction of the film can be accomplished can be by any means. Thus, the film can be coextruded and directly introduced into the mold cavity. Alternately, the produced film material can be accumulated, cut to size, etc., prior to positioning relative to the mold cavity surface.

Once the film is introduced into the mold cavity, a substrate material can be introduced into the mold cavity as at reference numeral 114 such that the film forms the outermost surface of the molded material upon completion of the mold cycle. It is contemplated that the injection molding process can be any suitable process for introducing a polymeric material such as a thermoplastic polyolefin (TPO) into the desired mold cavity to form the article of choice. The injection process occurs such that the introduced film forms an outermost surface of the resulting article formed of the molded material. Thus, location of injection port and selection of flow rates, injection pressures and the like will be adjusted to facilitate interposition of the film material between the cavity surface and the introduced injectable material.

It is contemplated that processing temperatures will be such that the film material is bonded to the substrate material in an essentially permanent fashion upon completion of the mold cycle. As used herein, the term “essentially permanent” is taken to mean that the substrate and overlying film material are integrally connected to one another throughout the life of the associated part.

In order to produce a molded article 10, a more detailed process such as that outlined in FIG. 4 can be employed. In order to produce the film layer having at least one layer of pigment material, the pigment particulate can be contained in a suitable pigment particulate concentrate that can be introduced into an appropriate extrusion device as at reference numeral 152. It is contemplated that the pigment particulate concentrate is a concentrate containing pigment material in a suitable polymeric matrix associated with a suitable encapsulating agent as discussed previously. The material can be introduced into an appropriate extrusion device by any suitable means such as batch feeding, continuous process, or the like.

The pigment concentrate can be integrated into a suitable polymeric processing stream as at reference numeral 154. Integration of the pigment precursor can be accomplished by any suitable method. As disclosed herein, one such method that is contemplated includes the pre-melting of the pigment concentrate and incorporation into the polymeric material process stream in a manner that preserves the a significant portion of the integrity of the pigment material introduced therein and minimized gel formation energy. It is contemplated that a suitable blending screw or twin-screw blending device can be employed to integrate the material into the polymeric process stream.

The polymeric process stream can be composed of a suitable a melt processible polymeric material that contains a suitable ionomeric polymer. Where desired or required, the polymeric matrix of the particulate precursor can be any suitable polymeric compound or composition capable of integration into the polymeric process stream. It is contemplated that various ionomeric materials may be employed.

Once the desired pigment has been integrated into the polymeric material process stream, the resulting material can be extruded into a film into contact with at least one additional polymeric film layer. It is contemplated that the polymeric material process stream and the additional polymeric film layer material can be coextruded to provide a multilayer film construct. The additional polymeric film layer can be composed of any material appropriate for the multilayer film construct. Examples of such materials include suitable ionomeric materials or other materials appropriate for a clear coat, additional polymeric material process stream layers containing suitable pigmentation or the like, suitable backing layers, and/or tie or adhesive layers. It is also contemplated that multiple layers can be coextruded to provide the final multilayer film construct.

he resulting multilayer film construct can be removed from the extrusion device and processed in any post-extrusion processes which may be desired or required. It is contemplated that the material can be stored in any suitable fashion, cut, and processed as desired or required, or subject to further treatment process as necessary or required.

In the process as disclosed herein, and outlined in FIG. 4, the resulting multilayer film is introduced into a suitable mold cavity as at reference numeral 158. The mold cavity can have any configuration or geometry suitable for producing the resulting end-use article. It is contemplated that the mold cavity can be one that is used with a suitable injection molding process and/or various injection/transfer processes. The multilayer film introduced into the mold cavity is positioned proximate to the surface of the cavity so as to be interposed between the mold cavity surface and material introduced into the mold cavity during the processing operation. Positioning can be by any suitable means. The multilayer film material can be held in position by any appropriate means including, but not limited to, electrostatic force and the like.

Once the film is in position in the mold cavity, a suitable substrate material can be introduced into the mold such that the film forms an outermost surface integral with substrate material as at reference numeral 160. Suitable substrate materials include, but are not limited to, suitable melt-processible elastomeric compounds such as TPOs.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

1. A multilayer film comprising:
a clear coat layer comprising at least one extruded optically transmissive thermoplastic polymer; and
a pigment layer comprising at least one extruded thermoplastic material and at least one particulate pigment interposed within the thermoplastic material, wherein the extruded thermoplastic is essentially uniform in polymerization.

2. The multilayer film of claim 1 wherein the extruded optically transmissive thermoplastic polymer and the extruded thermoplastic of the pigment layer are selected from the group consisting of ionomers and ionomeric precursors.

3. The multilayer film of claim 1 wherein the particulate pigment is associated with at least one carrier, the carrier material containing at least one extrudable thermoplastic material having a melting point between 100° C. and 250° C.

4. The multilayer film of claim 3 wherein the thermoplastic material of the carrier is selected from the group consisting of ionomers, ionomeric precursors, ionomer compatible polymers and mixtures thereof.

5. The multilayer film of claim 4 wherein the pigment is partially reacted with the thermoplastic material of the carrier material.

6. The multilayer film of claim 1 further comprising a backing layer, the backing layer in overlying relationship with the pigment layer at a location opposed to the clear coat layer.

7. The multilayer film of claim 6 wherein the backing layer contains an extrudable thermoplastic selected from the group consisting of melt-processible polyolefins.

8. The multilayer film of claim 6 further comprising at least one tie layer interposed between the backing layer and the pigment layer, the tie layer containing at least one extrudable thermoplastic exhibiting an affinity to the pigment layer.

9. The multilayer film of claim 8 wherein the tie layer further contains an extrudable thermoplastic exhibiting an affinity to the backing layer.

10. The multilayer film of claim 7 wherein the backing layer further contains an extrudable thermoplastic exhibiting an affinity to the pigment layer.

11. A polymeric article comprising:
a molded substrate; and
at least one polymeric layer overlying at least a portion of the substrate, the polymeric layer having a particulate pigment dispersed in an extruded thermoplastic material, the thermoplastic material characterized by essentially uniform polymerization.

12. The polymeric article of claim 11 wherein the polymeric layer contains at least one extrudable melt-processible thermoplastic selected from the group consisting of ionomers, ionomeric precursors, and mixtures thereof.

13. The polymeric article of claim 12 further comprising:
an optically transmissive layer in overlying relationship with the pigmented polymeric layer, the optically transmissive layer composed of an extrudable thermoplastic polymeric material.

14. The polymeric article of claim 13 further comprising a backing layer, the backing layer interposed between the pigmented polymeric layer and the substrate.

15. The polymeric article of claim 14 wherein the added substrate contains a polymeric material selected from the group consisting of polyolefins, polycarbonates, polyamides, and mixtures thereof, and wherein the pigmented polymeric layer contains at least one extrudable melt-processible thermoplastic selected from the group consisting of ionomers, ionomeric precursors, and mixtures thereof.

16. The polymeric article of claim 15 wherein the backing layer is bonded to the molded substrate and wherein the backing layer contains a extrudable thermoplastic material selected from the group consisting of polyolefins, olefinic thermoplastic elastomers, and mixtures thereof.

17. The polymeric article of claim 16 wherein the polymeric film further compresses to the layer interposed between the backing layer and the pigment layer, the pigment layer containing at least one polymeric having adhesive affinity to the polymeric material in the pigment layer.

18. A process for producing an article containing a pigmented polymeric film comprising the steps of:
introducing a polymeric film having a particulate pigment present in at least one layer into position in a mold cavity proximate to at least a portion of one surface of the mold cavity;
introducing a polymeric substrate material into the mold cavity such that the introduced substrate material contacts an inner face of the introduced polymeric film.

19. The process of claim 18 wherein the polymeric substrate is introduced into the mold cavity at a temperature sufficient to achieve bonding between the polymeric film and the introduced polymeric substrate.

20. The process of claim 18 wherein the polymeric film comprises at least one discrete layer having particulate pigment disposed therein, the at least one discrete layer containing a thermoplastic polymer selected from the group consisting of ionomers, ionomeric precursors, and mixtures thereof.

21. The process of claim 20 wherein the film further comprises at least one optically transmissive layer in overlying relationship with the pigmented layer interposed between the mold cavity surface and the pigmented layer, the optically transmissive layer containing a thermoplastic material selected from the group consisting of ionomers, ionomeric precursors, and mixtures thereof.

22. The process of claim 20 wherein the film further comprises a backing layer in linear relationship with the pigment layer, the backing layer interposed between the pigment layer and the introduced substrate material, the backing layer including at least one thermoplastic selected from the group consisting of polyolefins, and the polymeric substrate is composed of a polymeric material selected from the group consisting of polyolefins, polyamides, olefinic elastomers, and mixtures thereof.

23. The process of claim 20 wherein the polymeric film is extruded into the mold cavity.

24. The process of claim 20 wherein the polymeric film is extruded in a process comprising the steps of:
providing a polymeric process stream of melted thermoplastic containing particulate pigment therein;
introducing the melted thermoplastic into a polymeric process stream to produce a pigmented polymeric layer;
co-extruding the pigmented polymeric layer with at least one additional layer.

25. A pigment concentrate for integration into a polymeric process stream, the pigment concentrate comprising:
a polymeric carrier composed of a thermoplastic selected from the group consisting of ionomers, ionomeric precursors, ionomeric compatible materials, and mixtures thereof; and
particulate pigment incorporated into the polymeric carrier, wherein the polymeric carrier is configured to facilitate integration into a polymeric matrix material.

26. The pigment concentrate of claim 25 further comprising at least one compatibilizing additive, the compatibilizing additive present in a concentrate less than a volatilization threshold for the additive.

27. The pigment concentrate of claim 25 wherein the particulate pigment interacts with at least a portion of the thermoplastic material of the polymeric carrier.

28. The pigment concentrate of claim 25 wherein the particulate pigment is present in the carrier in a concentration up to 80% by weight of the polymeric carrier.

29. The pigment concentrate of claim 25 wherein the particulate pigment is present in an amount between 5% by weight and 20% by weight.
